(19) United States
(12) Patent Application Publication
(10) Pub. No.: US 2021/0321596 A1
(43) Pub. Date: Oct. 21, 2021

(54) Spreading Device

(71) Applicant: Atli Mar Josafatsson, Reykjavik (IS)

(72) Inventor: Atli Mar Josafatsson, Reykjavik (IS)

(21) Appl. No.: 17/258,923

(22) PCT Filed: Jul. 8, 2019
(86) PCT No.: PCT/IB2019/055793

§ 371 Date: Jan. 8, 2021

(30) Foreign Application Priority Data
Jul. 11, 2018 (GB) 1811369.6

(51) Int. Cl. A01K 73/04; B63B 79/15; G01V 1/38

(52) U.S. Cl. CPC A01K 73/04; G01V 1/3826; B63B 79/15

(57) ABSTRACT

There is provided a spreading device (100) for trawl fishing and seismic survey operations. The device has an upper frame (111), an intermediate frame (113) and a lower frame (112). There are at least two upper panels (22, 23) between the upper and intermediate frames, and at least two lower panels (22, 23) between the intermediate and lower frames. One of the upper panels and one of the lower panels adjustable in its angle of attack with respect to other panels. There is provided a manual means for adjusting the angle of attack of the adjustable panels.

Trawl doors, also known as otter boards, deflectors, paravanes and vanes, hereinafter collectively referred to as “spreading devices”, are used at opposite sides of a fishing trawl or opposite sides of seismic system to keep the fishing trawl open or a line of seismic guns and streamers in their correct use position.

Trawl doors are used to open a system of fishing gear. They are set from the vessel into the sea with its fishing gear connected between them. The doors spread out to each side from the vessel and generate a distance so that the gear, namely the fishing trawl, wires and cables herein after referred to as a “system”, are in optimal fishing conditions.

A trawl door is connected to a steel wire cable or a synthetic rope leading from the vessel, and the fishing net is connected to the trawl door in the opposite direction with another set of steel wire cables or synthetic ropes.

Trawl doors are generally used in pairs where the trawl door on the right side is called “starboard door” and the trawl door on the left side is called “port door”.

Deflectors, paravanes or vanes are used to spread a system of streamers for a seismic survey. They are also used in pairs and are set from the vessel in a similar manner to trawl doors in order to pull the streamers to each side of the vessel.

Paravanes are almost without exception, connected to synthetic ropes leading from the vessel and the seismic system, between the streamers and other components are also connected with synthetic ropes.

In essence, trawl doors and paravanes have the same purpose, to spread and hold the components in position therebetween.

Overall in the industry, the method to change the positioning of a trawl door or paravane, its angle of attack or pitch or roll, is both a complex and time consuming process as it is necessary to pull the spreading device to the surface to the vessel or onboard the vessel. Connecting units, shackles, connector or hooks leading to and from the spreading devices are disconnected and re-connected in different positions and the system is set out again into the sea.

It is known to construct a trawl door in such a way that the lateral force which it exerts is adjustable. Our European Patent No EP 2734039 B1, it is described and claimed: “A spreading device (10) for trawl fishing and seismic survey operations, the device comprising:-
an upper frame (11) defining a top edge of the device;
a lower frame (12) defining a bottom edge of the device;
an intermediate frame (13) between the upper and lower frame;
at least two upper panels (16, 18) connected between the upper frame and intermediate frame, wherein each of the at least two upper panels have a leading edge and a trailing edge;
at least two lower panels connected between the intermediate frame and the lower frame, wherein each of the at least two lower panels have a leading edge and a trailing edge;
driving units (25) mounted on (i.) the upper frame and the lower frame; or (ii.) the intermediate frame; or (iii.) the upper frame, the lower frame and the intermediate frame, and adapted to alter the position of at least one of the upper panels (16, 18) and the lower panels, the driving units (25) adapted to be controlled remotely, when the device is in use being towed through the water; wherein at least one of the at least two upper panels (16, 18) or at least one of the at least two lower panels is adjustable independently to adjust the position of the panels closer to each other or further apart to control water flow through the device between the at least two upper panels from the leading edge to the trailing edge and between the at least two lower panels from the leading edge to the trailing edge.”

The object of the present invention is to provide a manually adjustable spreading device.

According to the invention there is provided a spreading device for trawl fishing and seismic survey operations, the device comprising:
an upper, an intermediate and a lower frame;
at least two upper panels between the upper and intermediate frames;
at least two lower panels between the intermediate and lower frames:
   one of the upper panels and one of the lower panels being adjustable in its angle of attack with respect to other panels; and
manual means for adjusting the angle of attack of the adjustable panels.

Normally one or more upper panels and one or more lower panels are fixed, preferably the aftermost panels in the device, with the other panels being adjustable. There may be only single forward panels or two or more forward panels. In the preferred embodiment there are two forward panels. One only of these may be adjustable, but preferably they both are.

The adjustable panels could be pivoted at trailing edges or intermediate axes between the respective frames. However, in the preferred embodiments they are pivoted substantially at their leading edges.

The manual adjustment means is conveniently provided by sets of apertures aligned at different angles and able to receive pins to set the adjustment. The apertures can be arrayed in the direction of adjustment, i.e. circumferentially with respect to the local direction of adjustment. However, they are preferably arrayed obliquely, whereby finer adjustment is achievable.

It is envisaged that the manual adjustment means can be provided at one or all of the frames, though they are preferably at the intermediate frame. The adjustment means can be provided on the top side of the intermediate frame, preferably however, they can be provided on both the top and bottom side of the intermediate frame.

To provide interconnection of the frames at the leading edges of adjustable panels, fixed members can be provided close to the leading edges. Preferably these are hydrodynamically shaped in cross-section to divide flow past them to respective sides of the panels.

To help understanding of the invention, a specific embodiment thereof will now be described by way of example and with reference to the accompanying drawings, in which:

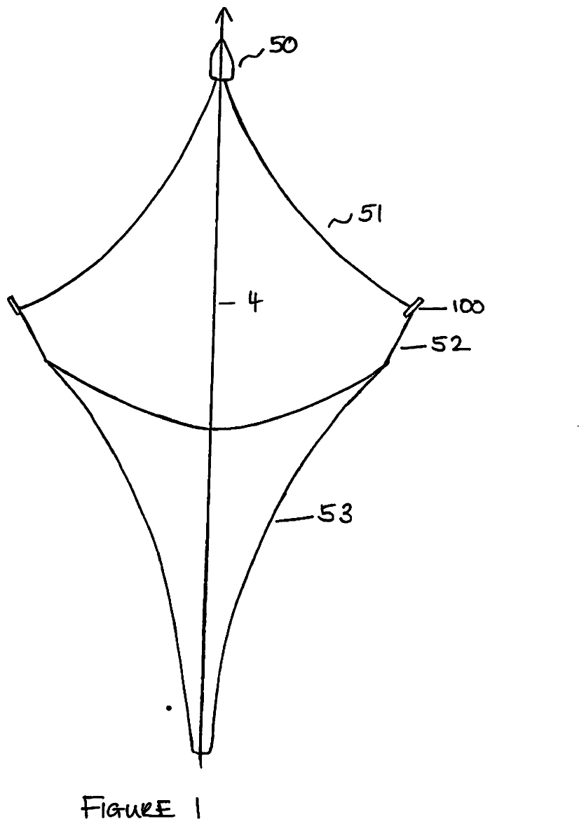

FIG. 1 is an aerial diagram of a fishing vessel towing a system of fishing gear;

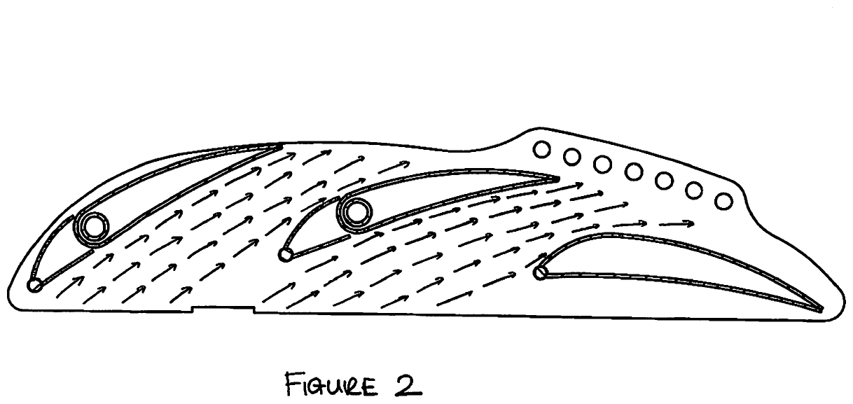

FIG. 2 is an top cross-sectional diagram of the device showing the hydrofoils in an open position and the direction of the water flow through them;

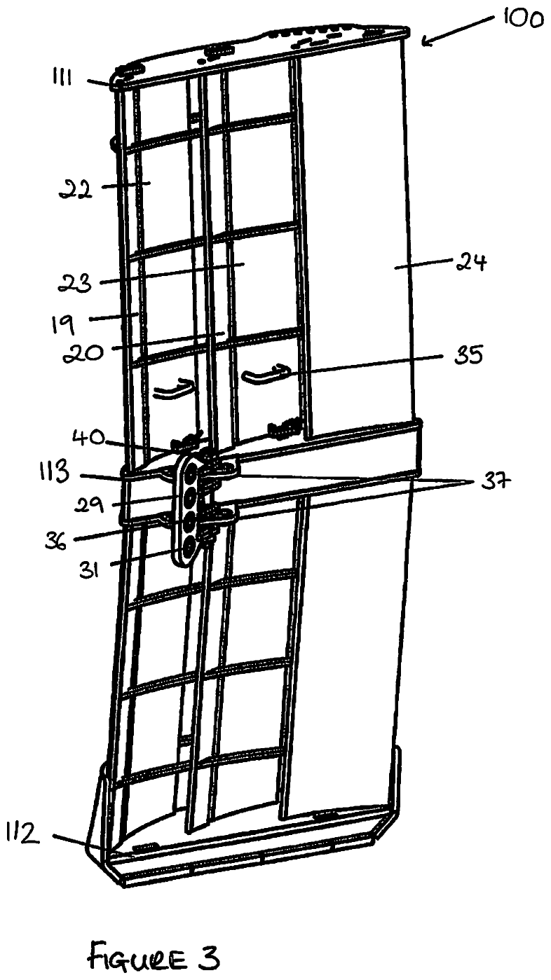

FIG. 3 is a perspective diagram of the inner face of the spreading device;

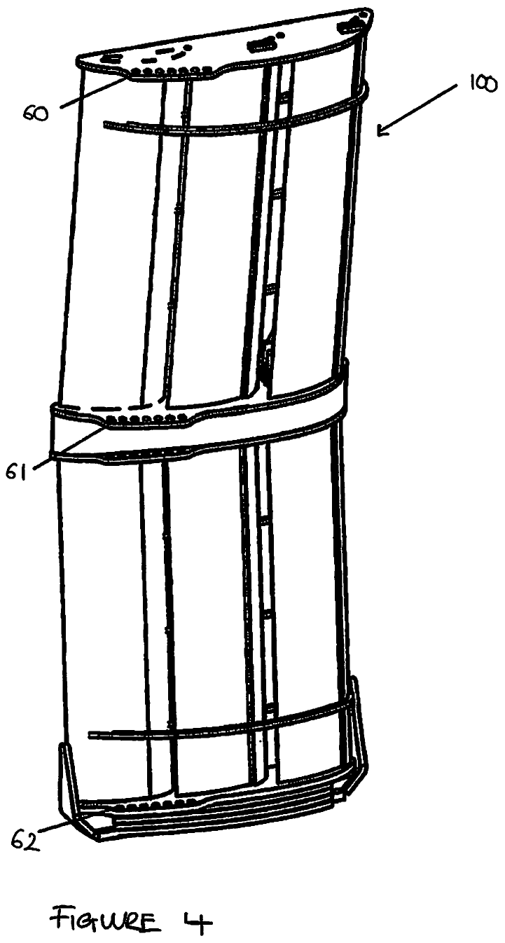

FIG. 4 is a perspective diagram of the outer face of the spreading device;

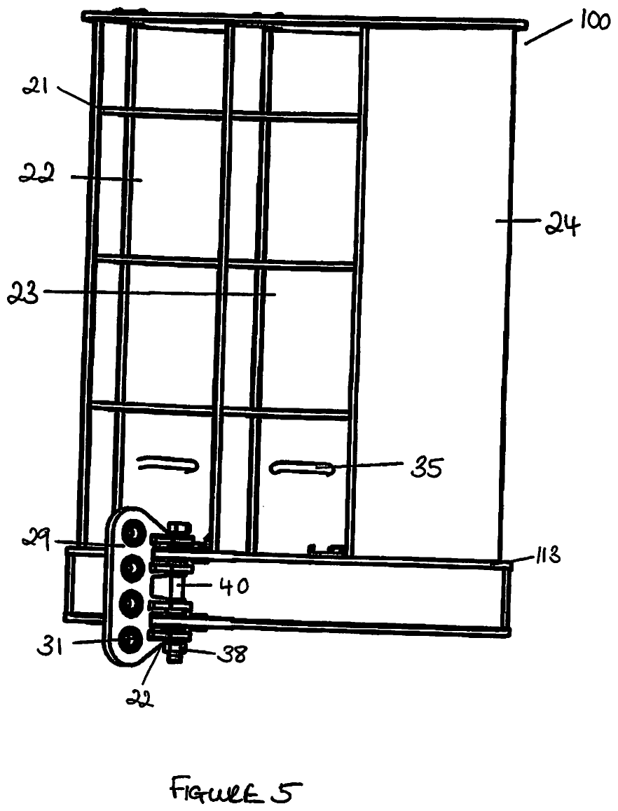

FIG. 5 is a front diagram of the inner face of the upper frame of the spreading device;

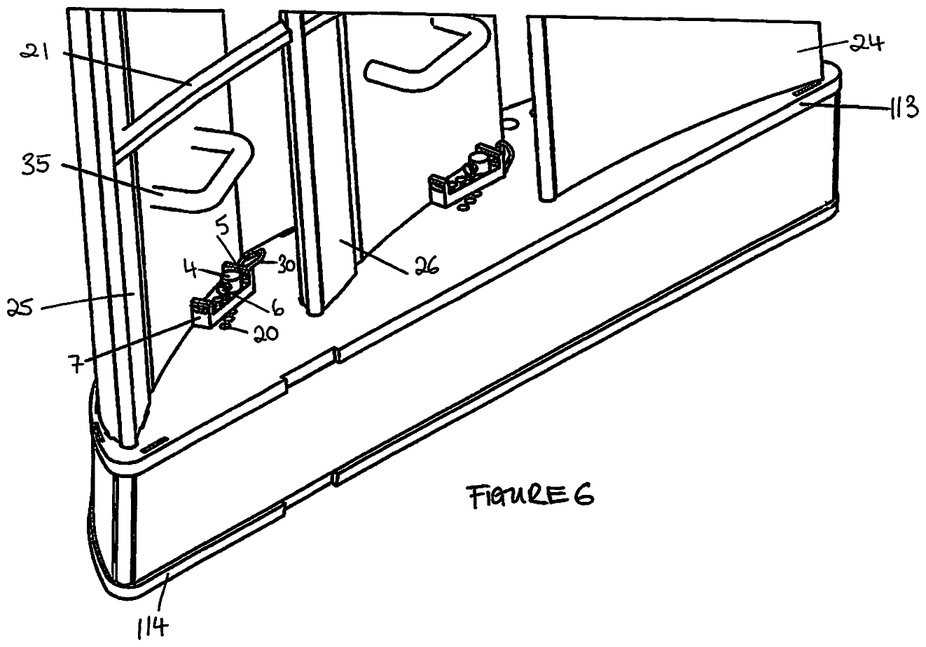

FIG. 6 is a perspective diagram of the adjustment mechanism on the intermediate frame;

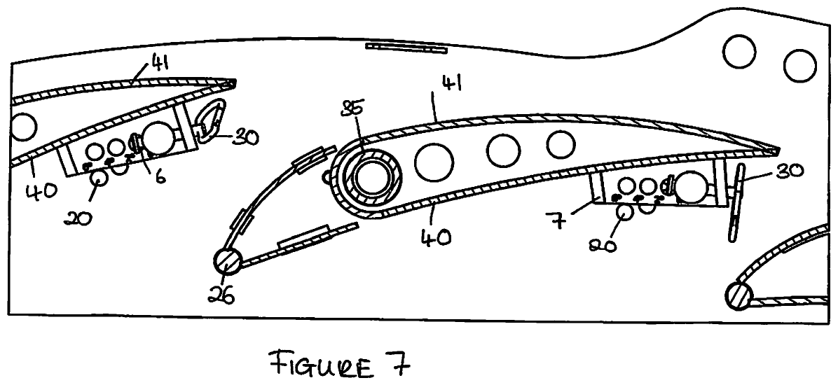

FIG. 7 is a top diagram of the adjustment mechanism on the intermediate frame; and

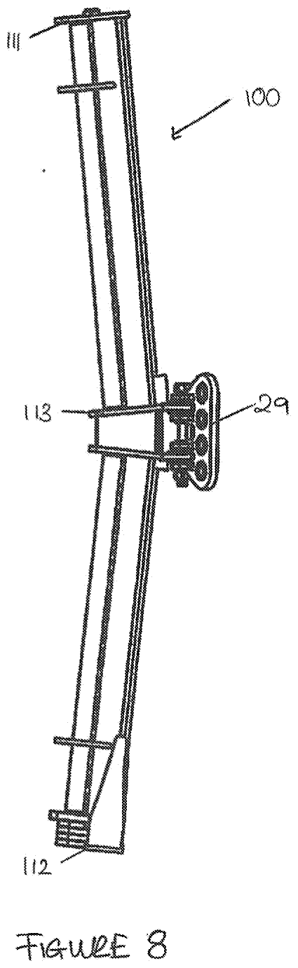

FIG. 8 is a side diagram of the spreading device.

Referring to the drawings, FIGS. 1 and 2 (FIGS. 1 and 13a respectively, as taken from our previous application EP 2734039 B1), show an aerial diagram of fishing vessel 50 towing a system of fishing gear comprising a pair of spreading devices 100 connected to the towing cables 51 and bridles 52 from the spreading device to the fishing trawl 53. The drawing shows the towing direction 4 of the fishing vessel and position of the fishing gear.

The spreading device 100 of FIG. 2 (13a) comprises a first panel or hydrofoil body 22, second panel or hydrofoil body 23 and third panel 24. The Figures show flow of water between the panels to spread the trawl.

The spreading device 100 of the invention has an upper frame 111 and a lower frame 112, separated by an intermediate frame 113. Between the upper and intermediate frame, there are three panels. The first two panels or hydrofoils 22, 23 are adjustable and have fixed leading edges 25, 26. These extend structurally between the frames, that is the leading edges 25, 26 welded to the upper frame 111 and the intermediate frame 113 and the intermediate frame 113 and the lower frame 110.

Third, after panels 24 fixedly interconnect the upper & intermediate and intermediate & lower frames respectively.

Both the upper and lower first and second fixed leading edges, 25, 26, are supportingly welded to each other by horizontal bars 21, with the second leading edge 26, being welded to the fixed third panel 24. These bars extend at both the front and rear faces of the spreading device 100 to act as a protection for the hydrofoil bodies.

The first and second hydrofoils 22, 23, have pivot round bar handles 35 extending between sockets (not shown) in the respective frames. The first and second hydrofoils have inner and outer panel plates 40, 41, which are curved to provide the panels with hydrodynamically induced lateral force.

For pivotal adjustment of the hydrofoils 22, 23, as shown FIG. 6, the intermediate frame 113 with apertures 20 on its top face, with the same number of apertures mirrored on the bottom face of the frame 114. The apertures are arranged in such a way so as to provide fine adjustments in the angle of attachment of the hydrofoils, namely between 0 and 12°, increasing in increments of 2°. That is to say, whilst they are arranged in front of their panels, each overlaps its neighbours in a direction away from its panel when pinned thereto, whilst successively deviating from the panel.

By adjusting the position of the first and second hydrofoils, 22, 23, the volume of water passing through the spreading device 100 is controlled, and as a result, so is the force exerted on the hydrofoils. This allows the device's position in the water to be altered, either vertically or horizontally.

A lug 7 is attached to the base of first and second upper hydrofoils by a bolt 4 that extends through it, passing through the chosen aperture in the intermediate frame 13 to hold the lug in place. A pin 6 passes through the head of the bolt 4 and subsequently through an aperture 5 in the side of the lug, thus restricting rotation of the bolt. A carabiner 30 passes through a slot in the end of the pin 6 to hold it in place.

The spreading device 100 has a slight inward facing curvature wherein the upper and lower frames extend in opposite directions from the intermediate frame 113.

There are a pair of apertured wings 37 extending inwards from the upper and lower faces of the intermediate frame 113. A threaded screw 40 extends through the apertures on both of the wings 37, to be secured in place by a nut 38 on the underside of the bottom wing. The screw 40 passes through four ears 36 on a plate 29, the plate itself having four separate apertures 31 onto which the towing cables will attach. The to ears 36 and the intermediate frame 113 being separably supported by individual hollow tubes 22. The plate can be rotated about the screw to adjust its radial position, thus altering the attachment position of the towing cables.

The outer face of the spreading device 100 is shown in FIG. 4, and includes an outer protruding rim on the upper, intermediate and lower frames, 111, 113 and 112 respectively, each of them having a number of apertures 60, 61 and 62 respectively, onto which the fishing trawl will directly connect.

The upper first and second hydrofoil bodies, 22 and 23 respectively, have a handle 35 each in order to aid the user to physically adjust the position of the hydrofoils.

The invention is not intended to be restricted to the details of the above described embodiment. Alternatively, the bolts 4 could be held in place using an alternative locking mechanism such as a linchpin or split pin that is directly attached to the bolt, rather than through a pin 6.

Furthermore, the bolts 4 could have a threaded end such that upon passing through the aperture, they can be locked in place with a nut.

It can be envisaged that any other suitable locking mechanism could be used instead of a bolt, pin and R-clip.

1-14. (canceled)

15. A spreading device for trawl fishing and seismic survey operations, the device comprising:
an upper, an intermediate and a lower frame;
at least two upper panels between the upper and intermediate frames;
at least two lower panels between the intermediate and lower frames;
one of the upper panels and one of the lower panels being adjustable in its angle of attack with respect to other panels; and
manual means for adjusting the angle of attack of the adjustable panels in the form of:
a set of apertures on a movable panel and a set of apertures on a fixed panel, differing pairs of the apertures being capable of alignment upon movement of the moveable panel.

16. A spreading device according to claim 15, wherein at least one of the panels is fixed.

17. A spreading device according to claim 15, wherein the adjustable panels are pivoted about their leading edge.

18. A spreading device according to claim 15, wherein the adjustable panels are pivoted about an intermediate axis positioned between respective frames.

19. A spreading device according to claim 15, wherein the adjustable panels are pivoted about their trailing edge.

20. A spreading device according to claim 17, wherein fixed members are provided close to the leading edges.

21. A spreading device according to claim 20, wherein the fixed members hydrodynamically shaped in the cross-section.

22. A spreading device according to claim 16, wherein the manual adjustment means is provided on at least one of the frames.

23. A spreading device according to claim 22, wherein the manual adjustment means is provided on a top face of the intermediate frame.

24. A spreading device according to claim 22, wherein the manual adjustment means is provided on a both the top and bottom face of the intermediate frame.

25. A spreading device according to any claim 24, wherein the apertures are adapted to receive a pin.

26. A spreading device according to claim 24, wherein the apertures are aligned opposite obliquely with respect to the local orientation of the adjustable panel.

27. A spreading device according to claim 24, wherein the apertures are arranged in the direction of adjustment.
